(19) United States
(12) Patent Application Publication
(10) Pub. No.: US 2024/0386774 A1
(43) Pub. Date: Nov. 21, 2024

(54) CASINO PODS PROVIDING REAL-TIME REMOTE GAMEPLAY

(71) Applicant: Interblock d.o.o., Las Vegas, NV (US)

(72) Inventor: John Joseph Connelly, Las Vegas, NV (US)

(21) Appl. No.: 18/390,135

(22) Filed: Dec. 20, 2023

Related U.S. Application Data
(60) Provisional application No. 63/504,484, filed on May 26, 2023.
(60) Provisional application No. 63/502,811, filed on May 17, 2023.

(51) Int. Cl. G07F 17/32

(52) U.S. Cl. CPC G07F 17/3216; G07F 17/3211; G07F 17/3225

(57) ABSTRACT

The present disclosure relates to a gaming pod providing a plurality of individual gaming machines, including at least one gaming machine remotely playable by a user device. Various embodiments include a structure surrounding the plurality of individual gaming machines, located on a casino floor. The structure may define and at least partially enclose a gaming floor on which the plurality of individual gaming machines is located.

### CROSS-REFERENCE TO RELATED APPLICATIONS

The present applications claims a right to priority to U.S. Patent Application No. 63/504,484, filed May 26, 2023, and U.S. Patent Application No. 63/502,811, filed May 17, 2023, the entireties of each of which is incorporated by reference herein.

### TECHNICAL FIELD

The present disclosure relates generally, but not exclusively, to the field of gaming, particularly live gaming systems providing remote gameplay.

### BACKGROUND INFORMATION

Casinos offer a variety of games to attract players. Such games may include live table games (e.g., roulette, craps, blackjack, etc.), virtual games, physical machines (e.g., slot-like machines), individual player machines, stadium-style group stations, and various gameplay combinations. Traditionally, players must physically go to a casino or the gaming location to participate. However, this may not always be possible, and when players are unable to play at a casino, the casino does not receive the business and the player misses out on the gaming experience.

Although online gaming platforms provide one way for players to remotely participate in casino games and other gaming events, the online experience is very different than in-person and live gaming events at an actual location. Many players enjoy playing at a particular casino or gaming location, or a particular machine, and online gaming platforms cannot provide a comparable experience and familiarity.

Additionally, players have many game types, options, and platforms available. Casinos and gaming providers must continuously innovate to attract and retain players, maintain profitability, and improve player experience.

Players at a gaming location may also take breaks from gameplay. Players may stop playing at a physical gaming machine or a live table game in order to eat, grab a drink, rest, or meet up with others. In some cases, the player may still wish to play despite being unable to physically be at the gaming machine.

### SUMMARY

An embodiment is directed to a gaming pod comprising a plurality of individual gaming machines and a structure surrounding the plurality of individual gaming machines. The structure may define and at least partially enclose a gaming floor on which the plurality of individual gaming machines is located. The structure may be located on a casino floor. A first individual gaming machine may be remotely playable by a user device, and a second individual gaming machine may be operable by a live player. An individual gaming machine may be a slot machine.

According to various embodiments, the structure may include a roof above the plurality of individual gaming machines. The structure may be a dome including a rounded roof section sloping downwards and defining an entrance via one or more wall sections. The one or more wall sections may define at least one vertical opening providing access to the plurality of individual gaming machines. the structure may include at least one glass section serving as at least one of a window or a player entrance into the gaming pod. At least one individual gaming machine (also referred to herein as a player machine) may be visible through an entrance or window. In some examples, the structure fully encloses the plurality of individual gaming machines.

The plurality of individual gaming machines may be arranged to face outwardly, such that the first individual gaming machine is visible through at least one of a wall of the structure or an opening of the structure. The gaming machines may be arranged in a circle on the gaming floor and/or along a perimeter of the gaming floor. A lighting system, which may use light-emitting diodes (LEDs), may further provide lighting effects to at least one of: an exterior face of the structure, the gaming floor, or an interior area of the structure.

Some embodiments may include a gaming system enabling remote play of a first individual gaming machine. The gaming system may stream a live video output to the remote user device, and the live video output may provide a real-time view of the first individual gaming machine. A camera system mounted to the structure, or otherwise located within the structure, may capture the live video. The user device may be a smartphone, a personal computer (PC), or other gaming device.

These and other features will be more clearly understood from the following detailed description taken in conjunction with the accompanying drawings and claims. This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1A is an example of an enclosed gaming pod, in accordance with an embodiment.

FIG. 1B is another example of an enclosed gaming pod, in accordance with an embodiment.

FIG. 1C is an example of a gaming pod with at least one entrance, in accordance with an embodiment.

FIG. 1D is an example of a gaming pod with a seating area, in accordance with an embodiment.

FIG. 2A is an interior of a gaming pod, in accordance with an embodiment.

FIG. 2B is another example of an interior of a gaming pod, in accordance with an embodiment.

FIG. 2C is another example interior of a gaming pod, in accordance with an embodiment.

FIG. 2D is an interior of a gaming pod with a seating area, in accordance with an embodiment.

FIG. 3 is a diagrammatic view of an example gaming floor plan, in accordance with an embodiment.

FIG. 4 is a diagrammatic view of another example gaming floor plan, in accordance with an embodiment.

FIG. 5 is a diagrammatic view of gaming floor plan with in-person and remote gaming machines, in accordance with an embodiment.

FIG. 6 is a diagrammatic view of a gaming floor plan with gaming machines with a seating area, in accordance with an embodiment.

FIG. 7 is a diagrammatic view of a gaming pod ceiling plan, in accordance with an embodiment.

FIG. 8 is a cross-sectional side view of a gaming pod, in accordance with an embodiment.

FIG. 9 is a side view of a gaming pod, in accordance with an embodiment.

FIG. 10 is a side view of a gaming pod with an arched entrance, in accordance with an embodiment.

FIG. 11 is a front view of an enclosed gaming pod with an entrance, in accordance with an embodiment.

FIG. 12 is a front view of another gaming pod, in accordance with an embodiment.

FIG. 13 is a front view of another gaming pod example, in accordance with an embodiment.

FIG. 14 is a front view of another gaming pod example, in accordance with an embodiment.

FIG. 15 illustrates three gaming pods, in accordance with an embodiment.

FIG. 16 is a floor plan view, including ceiling elements, of a gaming pod of FIG. 15, in accordance with an embodiment.

FIG. 17 is another floor plan view of a gaming pod of FIG. 15, in accordance with an embodiment.

FIG. 18 is a side view of a gaming pod of FIG. 15, in accordance with an embodiment.

FIG. 19 is another side view of a gaming pod of FIG. 15, in accordance with an embodiment.

FIG. 20 is a flowchart for live gaming operations, in accordance with an embodiment.

FIG. 21 is an illustration of an exemplary block diagram representing a general-purpose computer system in which aspects of the methods and systems disclosed herein or portions thereof may be incorporated.

### DETAILED DESCRIPTION OF EMBODIMENTS

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

Disclosed herein are systems and methods relating to gaming pods, which may be provided within a gaming location, such as a casino floor, and related real-time remote gameplay. A gaming pod may include a plurality of individual gaming machines, and a standalone structure surrounding the plurality of individual gaming machines. The structure may define, and at least partially enclose, a gaming floor on which the plurality of individual gaming machines is located.

Gaming pods and embodiments may provide a visual indication to players and others within a gaming location, such as a casino, that one or more individual gaming machines are available for remote gameplay. The gaming pods further enable gaming establishments to accommodate various player preferences, including but not limited to device and/or machine preferences, a type of game, a time of play, and a gaming location. Such techniques and embodiments may encourage and increase gaming, player entertainment, player satisfaction, and overall profitability.

Gaming pods also provide an area for players to go to and optionally play at when physical gaming machines on a main casino floor are occupied. Some gaming pods may provide a seating area, a bar, and/or food and drink options. Players may remotely play one or more gaming machines remotely, and in real-time, while enjoying such features. Players may also play the individual gaming machines from a remote location, such as their home or a hotel room. The gaming pods may include lighting systems, sound effects, and other features to mimic the look, feel, and experience of a casino. As such, gaming pods may be a “casino in a casino.”

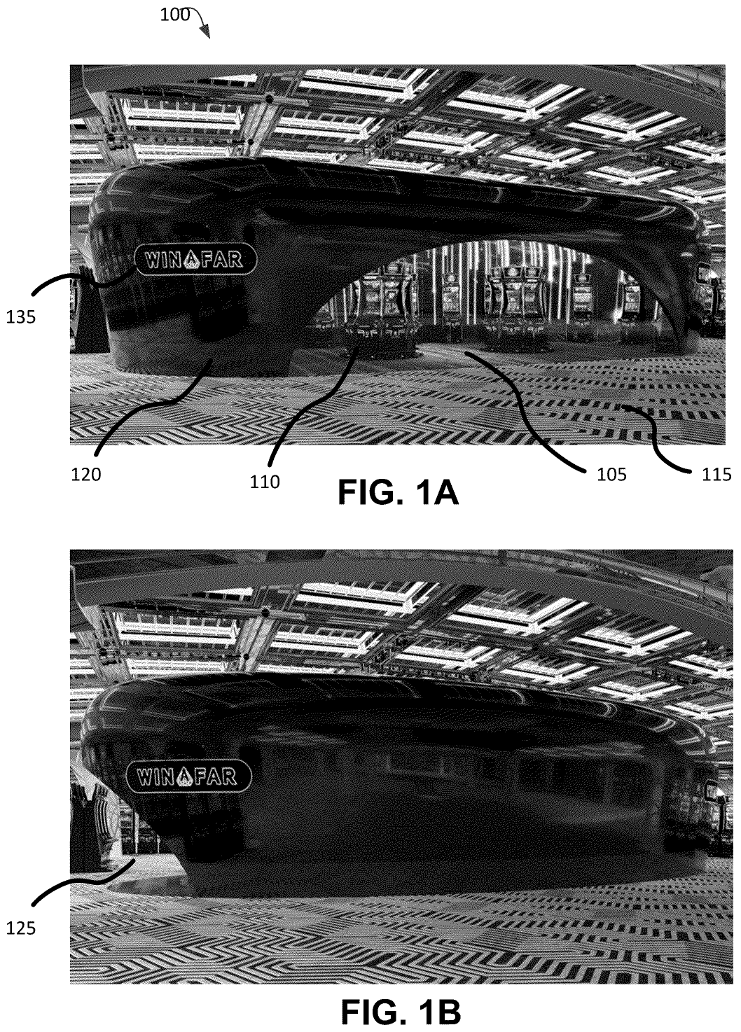

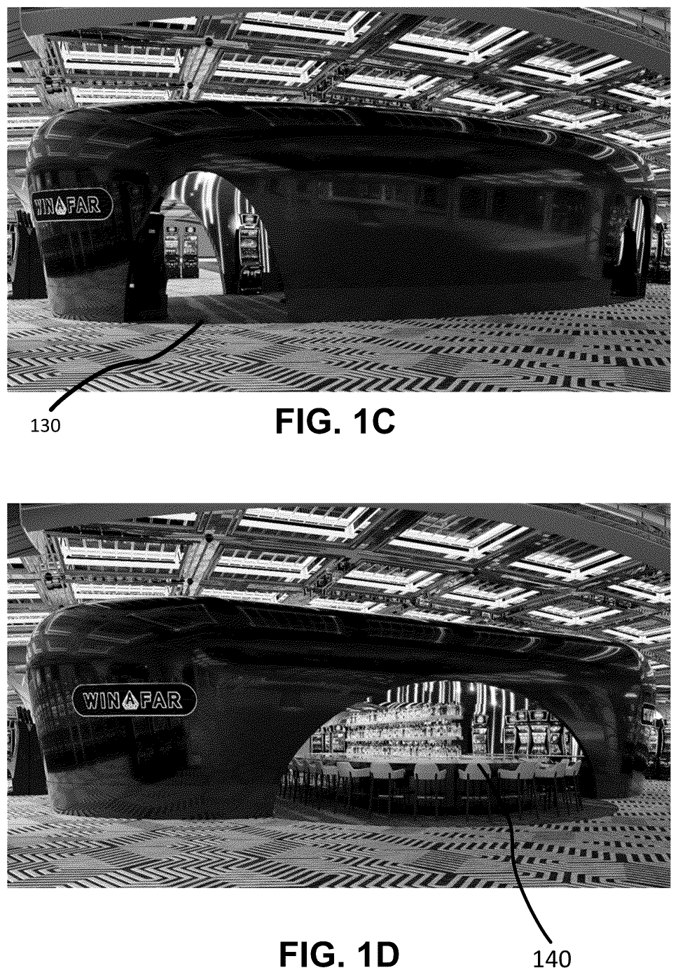

FIGS. 1A-D illustrate outer views of various gaming pod examples, in accordance with embodiments. FIG. 1A illustrates a gaming pod 100 including a plurality of individual gaming machines 110 and a structure 120 surrounding the plurality of individual gaming machines. The structure defines and at least partially encloses a gaming floor 105 on which the plurality of individual gaming machines is located. The structure may be provided within a gaming location, such as a casino floor 115.

Various gaming pod structures discussed herein may be placed inside a casino or other gaming establishment, providing a standalone structure within a room. The gaming pod may physically separate a set of gaming machines from other gaming machines on a casino floor.

The standalone structure of the gaming pod may serve to attract players and promote a sense of excitement and exclusivity by providing a set of gaming machines that are physically separated from other gaming machines on an open casino floor. As a standalone interior structure, the gaming pod may be visually appealing and attractive to players and passersby within the gaming location. The gaming pod's unique design and contained gaming machines may further pique the curiosity of players and potential players and promote engagement, especially for those looking for a secluded, private gaming area, or a change from the larger casino floor.

The gaming pod structure, floor plan, and features also enable players to continue playing when they would otherwise be unable to. For example, players can continue playing remotely, while getting something to cat or drink, or when they are not at a physical machine. This may attract more players, promote gameplay, and increase profitability since players may play when, where, and how they choose, and are not limited to playing at a physical machine. Additional features and amenities, such as a bar, sitting area, and lighting elements inside the gaming pod structure can further encourage player engagement and entertainment.

FIGS. 1A and 1B provide an example gaming pod structure 120 which fully encloses the plurality of individual gaming machines. An entrance 125 may include at least one transparent door or window to provide a view of the individual gaming machines within the gaming pod 100. This may be helpful to attract passersby and players in the gaming location to enter or otherwise inquire about the gaming pod and its offerings. The entrance 125 may include glass and be any of a plurality of shapes or arrangements. FIG. 1A, for example, provides an arched glass entrance along a side of the structure. FIG. 1B provides a glass entrance at one end of the structure.

The structure may include one or more visual elements 135, such as a sign or billboard, to advertise and attract players to the gaming pod. The visual elements 135 may include lights, sounds, or other attractive features to catch the attention of players and individuals on the casino floor on which the gaming pod is located. As discussed herein, visual elements may include LEDs, and lighting along an exterior and/or interior portion of the structure.

Figures IC and ID provide examples of gaming pod that are partially enclosed. The gaming pod of FIG. 1C includes at least one open entrance 130 through which individuals may enter the gaming pod. FIG. 1D provides open entrance and a seating area 140. In the example, a bar is provided within the gaming pod, with a counter-top and seating area extending from an interior portion of the gaming pod (e.g., the gaming floor), to an exterior portion of the gaming pod (e.g., the casino floor). In some examples, the seating area may be fully located within the gaming pod.

Gaming pods may be designed to include any of a variety of elements and features, including but not limited to the arrangements and designs illustrated in FIGS. 1A-1D. For example, a gaming pod may be fully or partially enclosed, include one or more entrances, seating elements, visual elements, lighting effects, and sound effects, among others. Gaming pods may be customized to attract certain players (e.g., slot machine players), provide excitement, encourage gaming, provide services (e.g., a restaurant, bar, etc.), and provide a variety of games (e.g., remotely playable, in-person, live gaming, etc.).

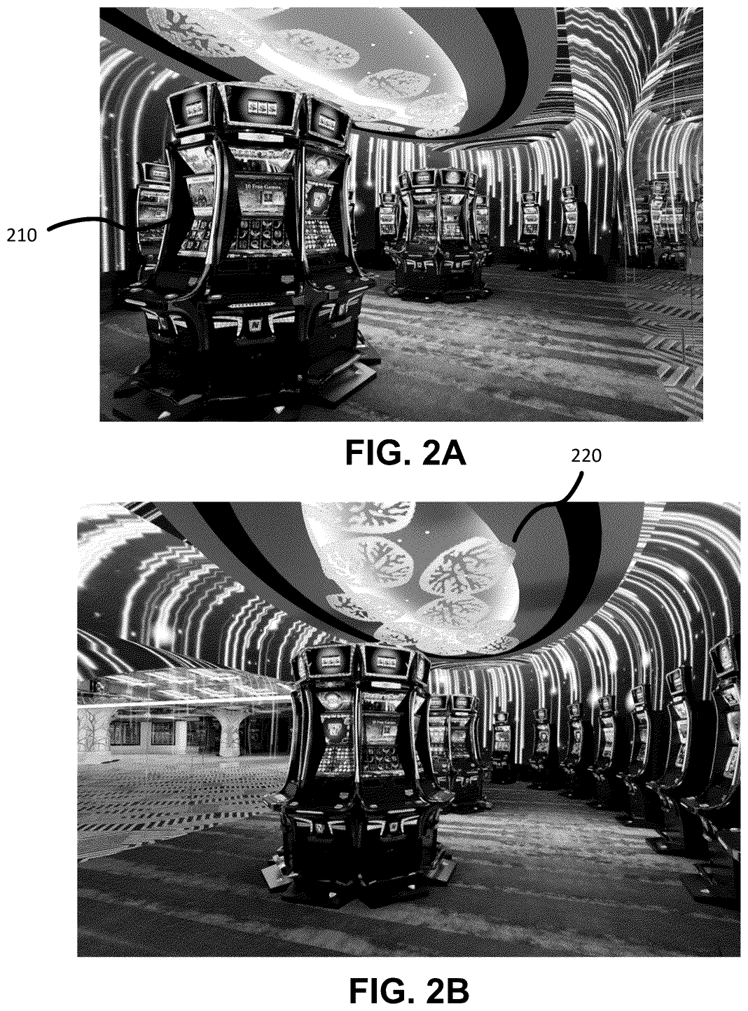

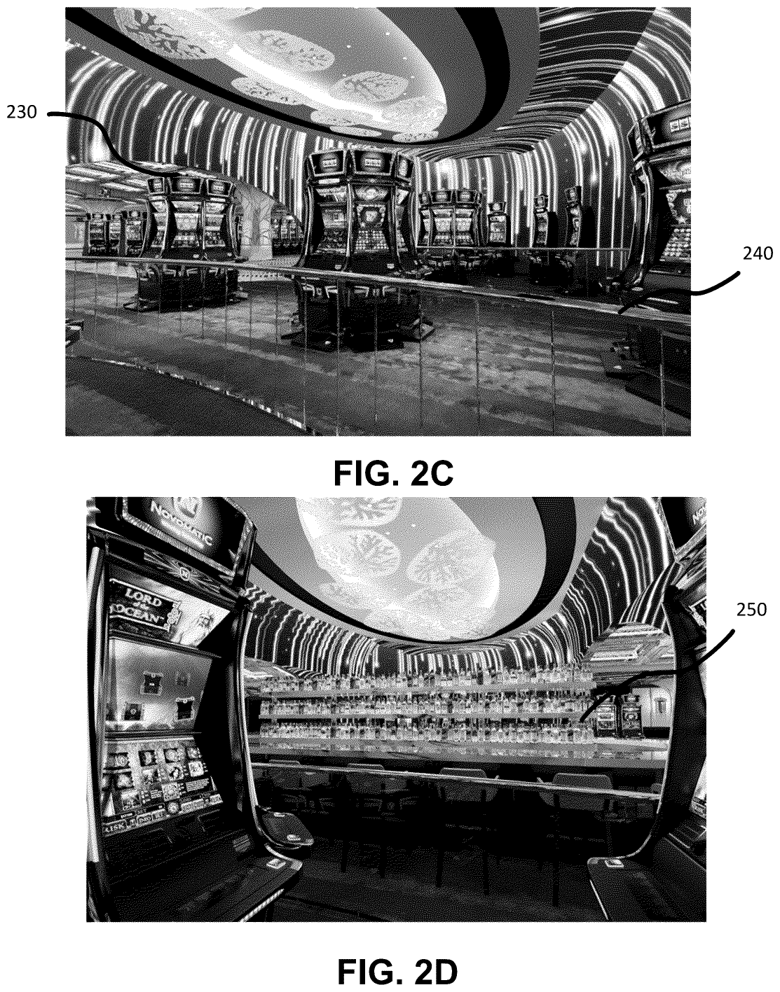

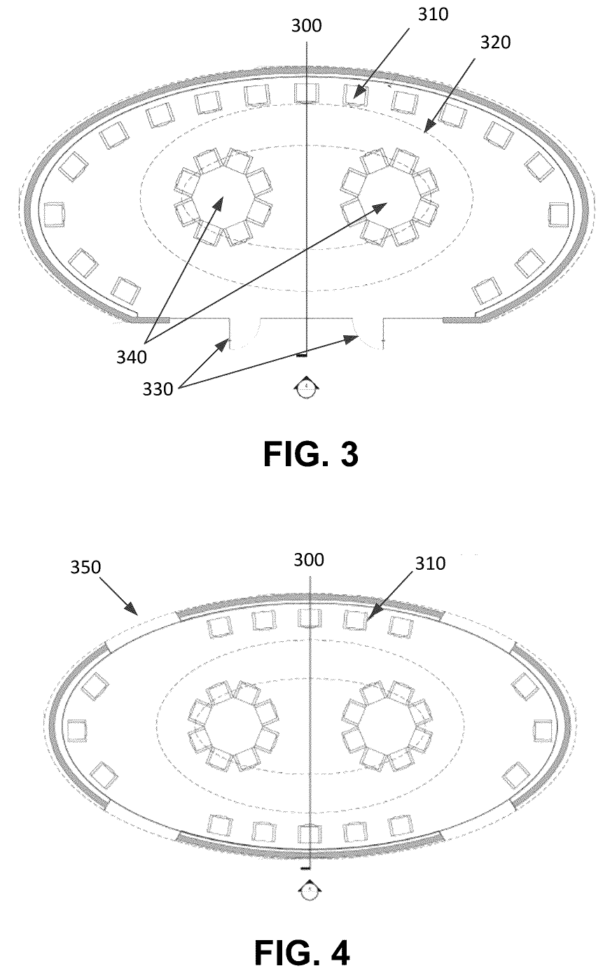

FIGS. 2A-D illustrate interior views of various gaming pod examples, in accordance with embodiments. A plurality of individual gaming machines 210 may be provided within the gaming pod. A ceiling element 220 may provide features such as lighting and camera systems. As further discussed in FIGS. 3-6, the plurality of individual gaming machines may be arranged in a variety of configurations.

In some examples, a gaming pod may include one, two, six, eight, ten, twenty, or more individual gaming machines. In larger gaming pods, the gaming floor may include significantly more individual gaming machines, ranging from twenty-five to one hundred machines or more, for example. Individual gaming machines may be arranged, for example, in outward-facing circular clusters 230. Gaming machines may also be provided along a perimeter of the gaming floor, as seen in FIG. 2B. In FIGS. 2C and 2D, the gaming machines may be separated from another area within the gaming pod, such as a bar 250, or a seating area. A divider 240, such as a bar or railing, may separate areas within the gaming pod. The interior of the gaming pod may be arranged so that a first area includes the gaming machines, and a second area includes another feature, such as a restaurant, bar, store, or seating area. Any of a variety of gaming machine arrangements may be provided on the gaming floor.

Such arrangements enable players to customize their gaming experience. For example, players may play an individual gaming machine 210 remotely, for example, while sitting at the bar, or at another location inside or outside of the gaming pod. The gaming pod may therefore provide an alternate gaming environment within a casino.

In various embodiments, one or more of the gaming machines are slot machines. However, gaming machines may provide any of a variety of betting and casino games, including but not limited to poker, craps, roulette, blackjack, other card games, dice games, and video games. In some examples, the plurality of individual gaming machines is remotely playable. In other examples, one or more gaming machines may also be played live. Some gaming pods may include a combination of gaming machine types, with a first plurality of individual gaming machines providing remote play only, and a second plurality of individual gaming machines providing in-person, live play and, optionally, remote play.

In some examples, players may place bets using a wallet saved on the user device. Funds may be transferred via the wallet to the gaming application or other means to place bets similar to how bets would be made at a physical gaming machine.

The gaming experience and gaming interactions at user device may occur in real time, thus providing a live gaming experience to players. This also allows players who are remote or otherwise unable to play directly on at a gaming machine to play. The remote control of the gaming machine, via any of the techniques discussed herein, enable more players to access the gaming machines. In addition to improving gaming access, the techniques also provide variety as to how games are played, which may also increase player interest, entertainment, and participation. Such improvements can further benefit the gaming location and its profitability since more players can access the games and play remotely, and the number of unoperated gaming machines at any given time will likely be reduced.

According to some examples, an individual gaming machine may include a universal cabinet. In some universal cabinet configurations, different games may be connected to a top of an upper section of the universal cabinet base. The base may include a lower section on which the upper section rests. A gaming machine may include a number of exterior elements that provide visual and audio effects. Such exterior elements may serve to attract attention to the game, entice someone passing by to play a game offered by the universal cabinet, or to enhance the play of a game being played at the gaming machine.

Individual gaming machines may include one or more physical elements such as soft touch gel buttons, gel arm rests, a footrest, and a control button that may be usable for different games. One or more physical elements may be remotely controllable during remote gameplay of the machine. As discussed herein, some machines within the gaming pods may be playable by a live person. In such cases, the one or more physical elements may be utilized during gameplay.

Other lighting effects that may be provided by an individual gaming machine include gel LED modules of different sizes and shapes and an ambient LED that may illuminate a bottom section. The gaming machine may further include a money/credit/card receiving/payout mechanism and a display. Speakers may provide some or all of the sound, depending on the nature of the game being played. For example, speakers may enable a variety of audio effects, and incorporate a range of speaker types, including but not limited to tweeters, midranges and subwoofers or woofers. The light and/or sound effects may be captured and projected to a remote user device during remote gameplay. Such features may aid in promoting an authentic, real-time experience, even though play may be occurring remotely.

In various examples, the inside of the individual gaming machine may include a controller module that may provide common connections for different games or different types of toppers and provide a USB connection to an embedded computer. In some examples, the embedded computer may be a GANLOT AMDY-7005, which is designed for gaming applications. The controller module may also provide outputs for the gaming machine lighting and buttons, which makes it possible to offer numerous gaming machine lighting designs. The controller module may also make it possible to quickly change toppers on the base. In some examples, only an upper section may need to be removed to access the controller module. Connections from the existing topper may be disconnected and the topper removed from the upper section. The new topper may then be attached to the upper section 102 and its connections plugged into the controller module.

In an embodiment, a switch in the controller module may then be switched to correspond to the new topper. In other embodiments, the new topper can be identified by connecting or plugging one or more additional modules for that topper into the controller module or changing a program of the embedded computer. This may make it possible to quickly change the type of game that is being played on the gaming machine without have to remove the base from its location, and without moving other machines or forcing the other machines to be shut down. This may also make it possible to prototype and develop other toppers for new games, further reducing development and production costs.

FIGS. 3-6 illustrate various gaming floor plans, in accordance with embodiments discussed herein. The floor plans are intended to be non-limiting examples, and various arrangements may be provided which fall within the scope of the present invention. For example, the number, arrangement, and type of individual gaming machines may be varied, as well as the gaming floor area, shape, gaming pod structure, color, shape, height, and length, among other things.

FIG. 3 illustrates a gaming floor layout including a plurality of individual gaming machines 310 positioned around a perimeter of the gaming floor and in two clusters, in the middle of the gaming floor. In the illustrated example, thirty-three gaming machines are provided, with seventeen around the perimeter and two clusters of eight gaming machines in the center. In some examples, there may be a total of thirty-five, forty, forty-five, fifty, or more gaming machines located on the gaming floor. The arrangement of gaming machines may be symmetrical about a central axis 300, as illustrated in the gaming floor layout.

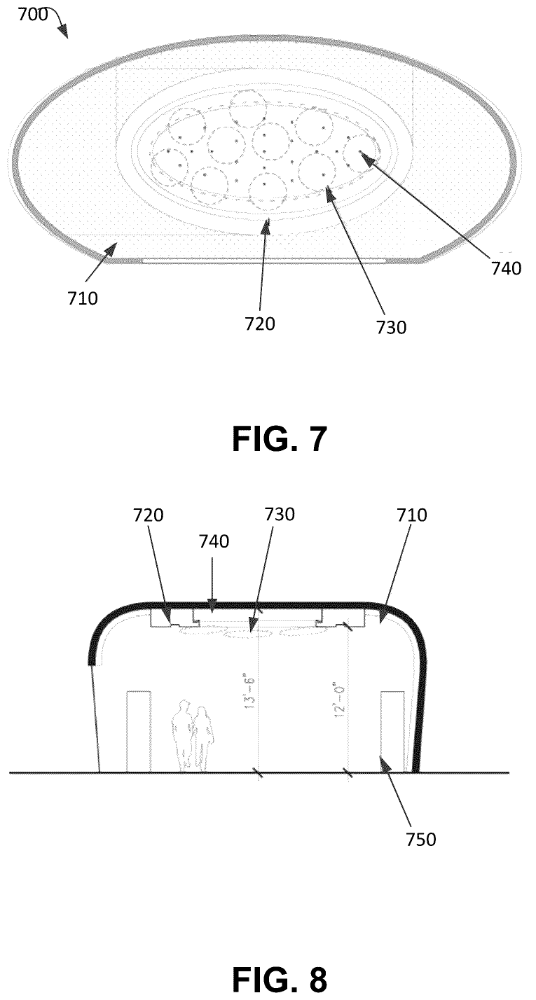

The gaming machine clusters 340 may include two, four, six, eight, ten, or more gaming machines. The machines may be arranged in a circle, and face outwardly. Outline 320 corresponds to a ceiling soffit (see, e.g., FIG. 7) which may be located within the structure, above the gaming machine clusters 340. In some examples, the gaming machine clusters 340 are centered beneath the ceiling soffit outline 320, which may include one or more lighting systems, camera systems, and visual features, as discussed herein.

FIG. 3 further illustrate a gaming floor plan with two entrances 330. As discussed herein, the gaming pod may be fully enclosed, for example, to separate the gaming floor and its gaming machines from the casino floor in which it is located. Some gaming pods may include more or less entrances, and the entrances may include doors, e.g., glass doors, or an open section where individuals may freely walk in and out.

FIG. 4 illustrates a gaming floor plan including four entrances 350 located on opposite, symmetrical sections of the gaming pod. In an example, the entrances are open and do not include any doors or barriers. The individual gaming machines 310 may be arranged around a perimeter of the structure, with a plurality of gaming machine clusters located in the center of the gaming floor. Similar to FIG. 3, the gaming machine arrangement is symmetrical, mirrored about a central axis 300.

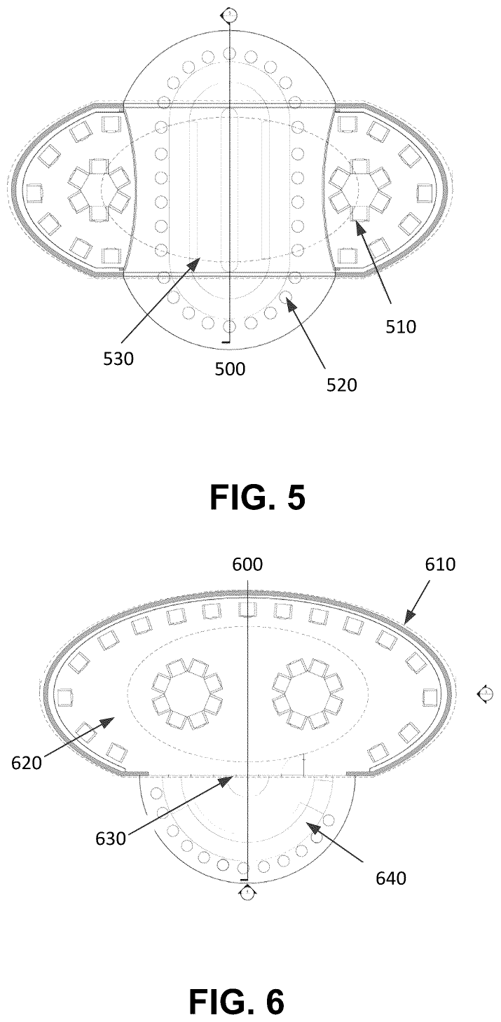

FIG. 5 illustrates a gaming floor plan including a seating area 520, a bar 530, and twenty-six gaming machines. The gaming floor plan is symmetrical about central axis 500. A bar 530 is positioned along a length of the central axis 500 and provides a seating area 520 with a plurality of seats (e.g., 30 seats), around the bar 530. The bar may provide food, drinks, and other refreshments to players. As discussed herein, the gaming machines 510 may be remotely playable machines, and players may play a gaming machine 510 while sitting at the bar or another location. In various examples, the gaming machine is a digital slot machine.

In some embodiments, the seating area 520 and the bar 530 may be separated, for example by a railing or other barrier (see, e.g., divider 240 of FIG. 2C). The gaming machines may be located in a first area or wing of the gaming floor, and in a second area or wing of the gaming floor. Gaming machines may be arranged along a perimeter, such as an outer wall of the structure. FIG. 5 shows a gaming cluster consisting of six gaming machines. As noted herein, gaming machines may be arranged in any of a plurality of ways.

FIG. 6 illustrates a gaming floor plan which may correspond to the structure illustrated in FIG. 2C. The structure may define and partially enclose the gaming floor 620 on which the plurality of gaming machines is located. A bar and seating area 640 may extend from an open entrance 630 into the gaming pod. In the example, the gaming floor includes thirty-three gaming machines, arranged around a perimeter 610 of the gaming floor, and in two, eight-machine clusters. The gaming pod floor plan may be symmetrically arranged about central axis 600. The bar and seating area may provide an inviting and welcoming location for players to sit at while playing a gaming machine remotely.

FIG. 7 illustrates a plan view of a gaming pod ceiling 700. A ceiling portion of a gaming pod may include at least one of a video wall 710, a camera system 720, a lighting fixture 730, and a lighting system 740. FIG. 8 illustrates a side view of ceiling elements 710-740 above the gaming floor, with gaming elements 750. A video wall 710 may provide visual elements via one or more lighting elements and displays. In various examples, the video wall may provide video, lighting effects, and other visual arrangements (see, e.g., FIGS. 2A-2D) to make the interior of the gaming pod more attractive, appealing, or entertaining to players.

The ceiling 700 further include a lighting fixture 730, such as a chandelier, and a lighting system 740. In some examples, the lighting system may operate in coordination with the video wall 710 and/or any lighting fixtures 730 to provide coordinated visual effects within and around the gaming pod.

The ceiling 700 may further include a camera system 720, which may include one or more cameras, image sensors, and a track system. According to some examples, cameras may provide live video output of one or more areas within the gaming pod. A camera may provide live video output of a gaming machine, thereby providing a live view to remote players of the gaming machine any time, before, during, or after play. According to some aspects, a camera may be provided for each gaming machine within the gaming pod. A camera may be placed in front of a gaming machine and capture live video of one or more areas of the gaming machine, such as a screen or a control area. In other examples, one or more cameras may be movable along a camera track mounted to the ceiling or other portion of the structure. One or more cameras may also be controllable by a remote user, so as to enable views of a desired machine or area within the gaming pod. The video output may be streamed to a user device, such as a smartphone, personal computer, or other gaming device.

In some examples, input at the user device may select a first camera within the gaming pod and live video output from the first camera may be viewed at a display associated with the user device. Input at the user device may also adjust the camera's video, for example, causing a closer view or zoomed in view of an object within the gaming pod such as a gaming machine, or moving the camera to focus on a different area. Such user device input may also enable live video feed switching between cameras, e.g., from a first camera to a second camera. In various embodiments, input received at the user device may also adjust any or all of the cameras' fields of views, to view a desired region of interest. Changes to camera views may occur before, during, or after gaming events, to promote control and gameplay customization by a player operating a user device.

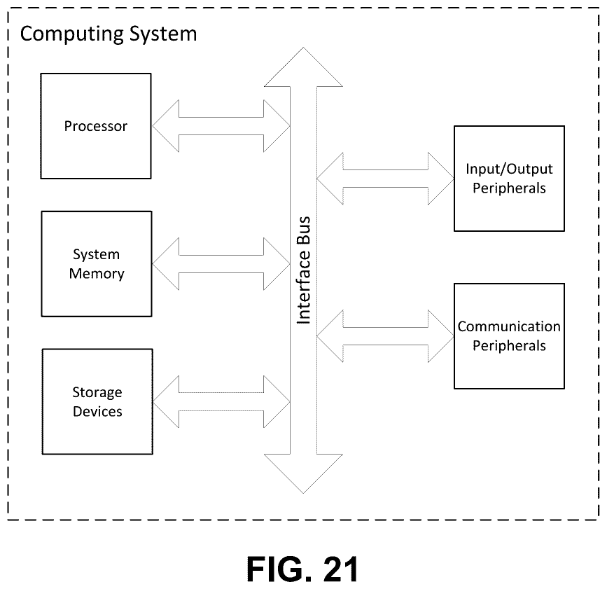

Some cameras may include an image sensor configured to capture image data on a continuous basis. The at least one image sensor may be configured to capture image data associated with particular game cycles of the games played at a gaming machine. The image sensor may provide the captured image data to a controller associated with the camera as a video stream, a sequence of individual image frames, raw image data, and the like. In an embodiment, a controller (in the form of a computer system, see e.g., FIG. 21) associated with the gaming machine and/or user device may configure the image sensor by specifying a frame-rate, a resolution, a color value, a video stream encoding format, a subset of the image sensor's available pixels to activate and/or deactivate, and the like.

In some examples, image data captured by an image sensor may provide a live video feed of operations happening at a gaming machine. The camera may capture image data for a predefined period of time, such as a particular game cycle. For example, such predefined periods may be associated with a slot roll, a betting window, or another event occurring at the gaming machine. The image sensor may also be configured to capture image data associated with a particular area of the gaming machine, such as a screen. As discussed herein, the image sensor may be remotely controlled, and the captured image data may correspond to input received at the user device.

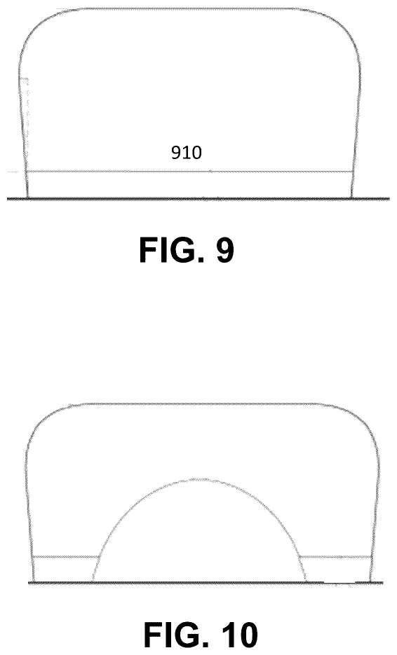

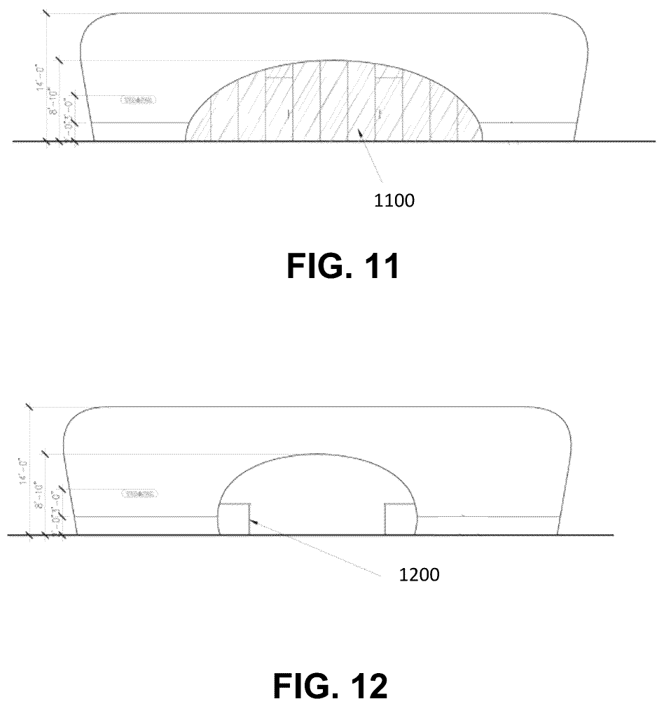

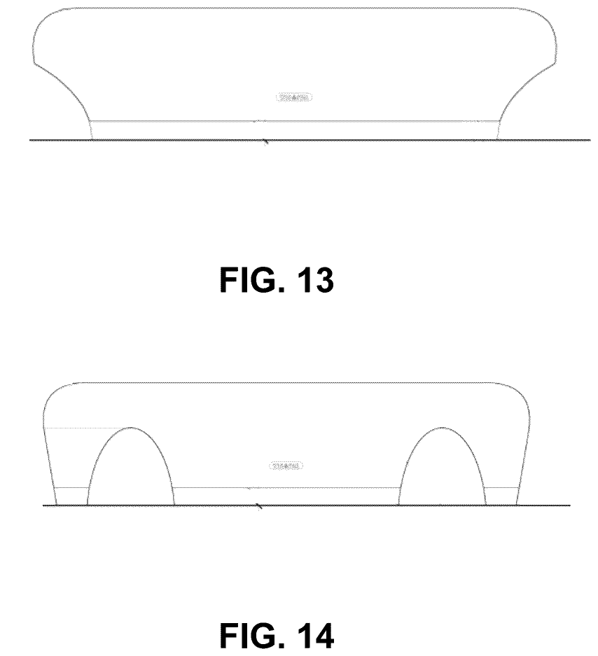

FIGS. 9-10 illustrate an example side view of a gaming pod. A siding 910 of the structure may be colored and formed of any of a variety of materials, such as plastic or metal materials, or other combinations of materials. As provided herein, the gaming pod and its structure may take any of a variety of shapes and sizes. For example, an upper section may be wider than a base section of the gaming pod. The gaming pod may be a rectangular, rounded, oblong, or dome-shaped structure. FIGS. 11-14 illustrate example front views of a gaming pod. Entrances may take an arched, rounded, or rectangular shape, and may include one or more glass panels 1100 or open entrances. One or more interior elements 1200 may be visible through the entrance. The interior elements may include a bar area, a seating area, a walkway, a railing, a lighting fixture, a visual element or other item to attract players.

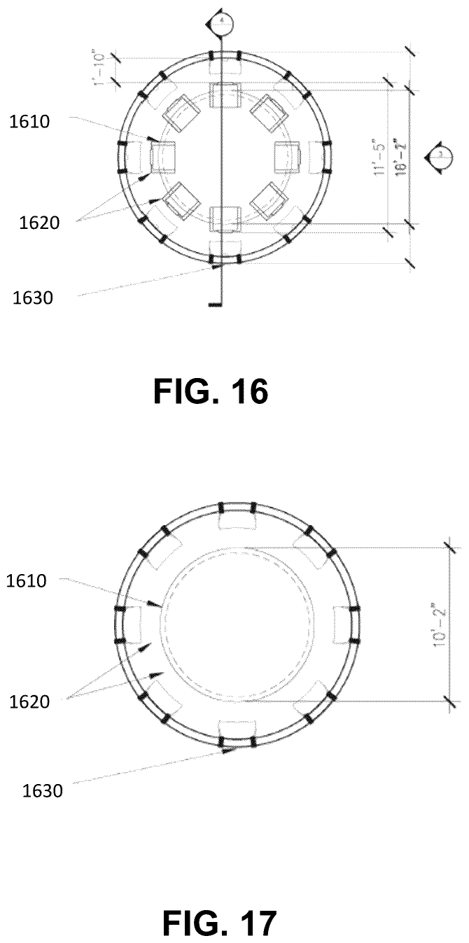

The design of the gaming pod may take any of a plurality of sizes and designs. A footprint size of the gaming structure may range from a floor plan of 6′×8′ up to 24′× by 55′ or larger. The gaming pod may also take a circular shape, with a circular footprint having a diameter of 8, 10, 11, 12, 13, 14-feet or larger (see, e.g., FIGS. 16-19). A height of the gaming pod may range from 7-15 feet for example. Gaming pod sizes, including floor plans and heights may be less or greater than the examples discussed herein.

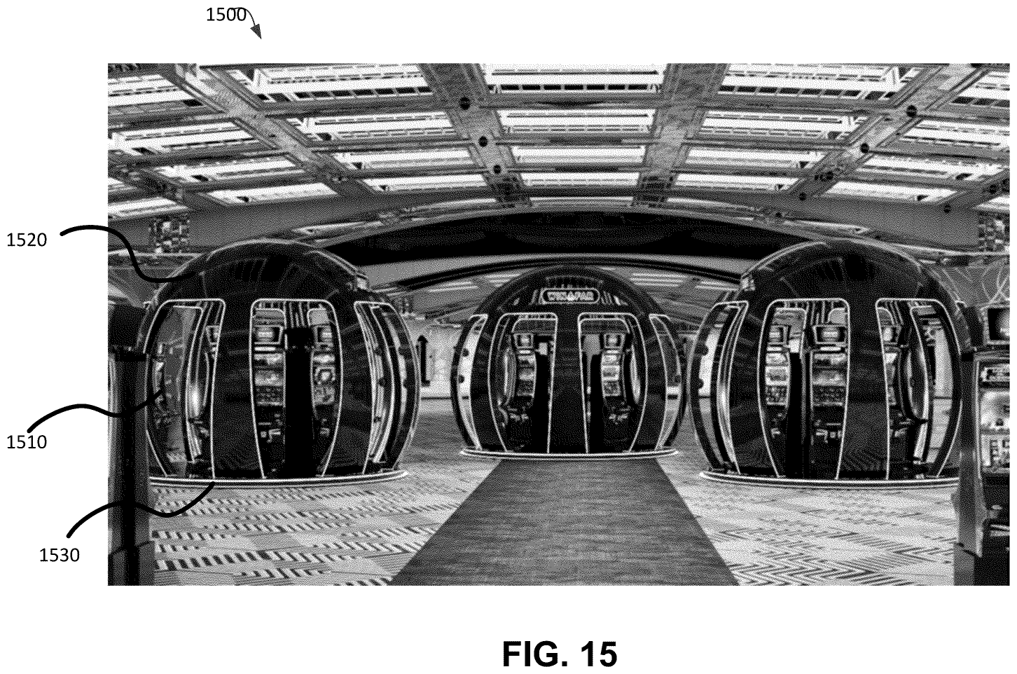

FIGS. 15-19 illustrate a rounded gaming pod 1500 in accordance with various examples discussed herein. FIG. 15 illustrates three rounded gaming pods located on a casino floor. The rounded gaming pod 1500 has a domed structure comprising a rounded roof section 1520 sloping downwards and defining at least one opening 1510. A plurality of gaming machines may be positioned within the gaming pod. The illustrated example shows six individual gaming machines arranged in a circle within the structure. More or less gaming machines may be provided based on sizing and design considerations.

The domed structure is formed such that the gaming machines are visible through the one or more openings 1510. In some examples, one or more lighting elements 1530 may be placed along at least one or a base section of the gaming pod, or around an opening 1510. The one or more lighting elements 1530 may provide visual effects to attract players and draw attention to the gaming pod 1500.

FIGS. 16-17 illustrate example floor plan views, and sizes, of the rounded gaming pod 1500 illustrated in FIG. 15. In FIG. 16, a plurality of individual gaming machines 1620 may be positioned symmetrically, and facing outwardly, around a circular gaming floor of the gaming pod. The individual gaming machines may be positioned directly beneath a ceiling soffit 1610. The ceiling soffit 1610 may contain one or more lighting fixtures, cameras, video wall elements, and other elements, similar to those discussed with respect to FIG. 7. An integrated LED exterior 1630 may be provided along an exterior portion of the structure.

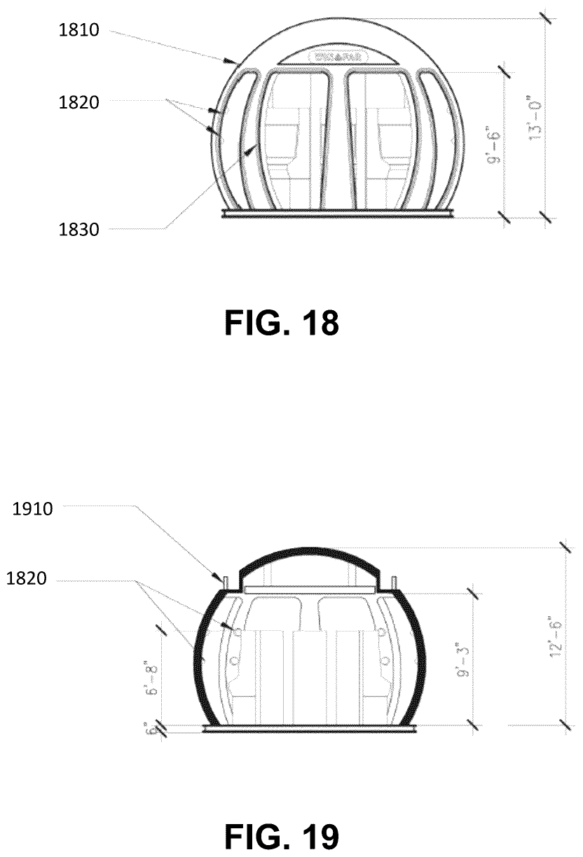

FIGS. 18-19 illustrate example side views, and sizes, of the rounded gaming pod 1500. Lighting elements may include an integrated exterior LED system 1810, which may provide lights in various colors, brightness, and timing to any of a plurality of exterior sections of the structure. For example, a lighted door trim 1830 may be provided on the rounded gaming pod. Other gaming pod elements may include a sign or billboard element 1910, or one or more video cameras 1820, as discussed herein. The video cameras may be attached to the structure, such as a wall, door frame, or ceiling soffit.

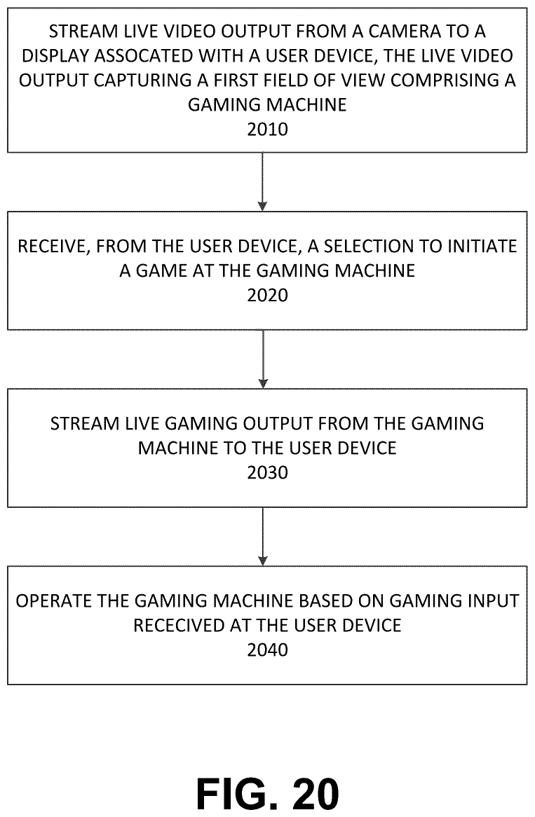

FIG. 20 provides a flowchart of a live gaming operation, in accordance with various aspects. Such operations may occur using one or more computing devices, including a processor and memory. Various techniques may utilize one or more cameras, user devices (e.g., cell phone, smartphone, PC, gaming device, etc.), player machines, or applications operating on a user device or other computing device. In some examples, a user device may include a downloadable application, which provides access to the camera and gaming machine(s) and manages one or more operations described herein. In some examples, the application may communicate with one or more remote computing devices, servers, databases, and computing elements to manage communications and operations between various devices.

At block 2010, aspects may stream live video output from a camera to a display associated with a user device, wherein the video output captures a first field of view comprising a gaming machine. At least one camera, for example, may be provided on, around, or within a gaming pod structure. The at least one camera may capture a first field of view corresponding to an area associated with the gaming pod, such as an interior portion of the gaming pod. In some examples, the first field of view may be a gaming floor associated with the gaming pod, the gaming floor including at least one gaming machine. The first field of view may also include a live view of an exterior portion of a gaming pod and/or a casino floor on which the gaming pod is located. The field of view may correspond to a viewable region, which may be provided on a display associated with the user device. In an example, the first field of view captures at least an area within or associated with a gaming pod having one or more remotely accessible gaming machines. In another example, the first field of view captures a gaming screen on a gaming machine and a surrounding element of the gaming machine. The surrounding element may be a screen bevel, a frame, a side portion of the gaming machine, among others. There may be one or more selectable regions within the first field of view. A selectable region may correspond to a gaming area on the gaming machine. In some examples, the selectable region may be generated based on an identification of one or more objects, such as a gaming machine, play station, and/or a display associated with a gaming machine, within the first field of view.

The first field of view may capture a gaming floor, including a plurality of gaming machines, which may be selectable from the user device to initiate a remote gameplay operation. In some examples, the live video output may be changed based on input received at the user device. For example, the live video stream may switch from a first video output from a first camera to a second video output from a second camera.

In various examples, the first field of view may be adjusted, via input at the user device, to a second field of view. In some examples the second field of view is an area within the first field of view. The first field of view may be a gaming area, and the second field of view may be a gaming machine element, such as a screen of a gaming machine. In other examples, the second field of view may be an area adjacent to the first field of view. As discussed herein, the determination may be based on a threshold, such as a visual threshold or a selection threshold. The threshold may, for example, correspond to a size of an object or an area relative to a size of the display of the user device. A user may enlarge or zoom in on an object, such as a display of a player station, and when the player station display size reaches a threshold amount (e.g., 50%, 60%, 70%, 80%, 90%, 100%) of the user device display, the second field of view may be determined to be associated with the gaming area. In other examples, reaching the threshold may initiate a selection of a selectable region within the first field of view. Similar to the first field of view, the second field of view may provide a view of an area or an object in real time.

At block 2020, aspects may receive input from the user device to initiate a game at the gaming machine. The input may include a tap, pinch, hold, or other motion or manipulation of live video output. The selection may also identify a particular gaming machine, an availability, or other gaming information. In some examples, the input may enable a zoom in or out on various areas within or surrounding the first field of view. The input may also include a motion performed on the display, the motion indicative of a selection of a gaming machine or gaming area on the gaming machine. The motion may be a zooming motion, a circular motion, a screen tap, or a screen hold. According to some aspects, the video output on the display may update in real-time, based on the player input.

In response to player input at the user device, the first field of view may update to a second field of view. In some examples, player input may cause the user device to zoom in to a region, such as a player station or a display associated with the player station, within the first field of view. The region may be a selectable region within the first field of view.

At block 2030, aspects may stream live gaming output from the gaming machine to the user device. The live gaming output may include video output from the gaming machine. Such video output may be similar to video output provided on the device if it were played in-person.

In some examples, adjusting a field of view, or video stream switch may transfer gameplay control from the gaming machine to the user device. The control transfer may occur after a determination that the second field of view corresponds to the gaming area. In some examples, the gaming machine may no longer be playable by a live player or another remote player, since its gameplay operation has been transferred to the user device.

Video output from the gaming machine may correspond to a game module associated with the gaming machine. Such video output would otherwise be provided at the gaming machine, such as on the display associated with the gaming machine, during gameplay by a live, in-person player. In some examples, the gaming machine video output may be provided on both the gaming machine and on the display associated with the user device.

At block 2040, aspects may operate the gaming machine based on gaming input received at the user device. The gaming input may correspond to gameplay on the gaming machine and enable operation of the gaming machine from the user device. A remote player may therefore select and play a particular gaming machine at a gaming location without being physically present at the gaming location. Such aspects may increase player choice and entertainment by enabling players to view live streams of a gaming location, select a particular gaming machine, and operate a live game on the gaming station, in real-time. Aspects may therefore simulate live gaming experiences for remote players, and provide a unique gameplay technique, which combines live, virtual, remote gameplay, with a physical gaming device. For example, the gaming input may be a selection, a command, such as a launch command, or an initiation of an operation, such as a seed determination. An external controller connected to the user device may be configured to perform gameplay operations and provide gaming input. As discussed herein, the live game may be craps, roulette, blackjack, or another card game, dice game, video game, virtual game, or table game.

Gaming input may generate one or more commands which are communicated to the gaming machine, to operate the gaming machine in a same manner as a live player at the machine. Live gaming output may, for example, provide a live view of a gaming screen that is reflective of the game provided at the gaming machine. A remote player may toggle between the gaming screen and a view of the gaming machine, and make selections at the user device, just as a live player at the machine would. Gaming input is reflective of the particular game being played, and may include, for example, selections to deal a card, select one or more symbols on a betting layout, initiate a launch, place a bet, cash out, and the like.

In some examples, the live gaming output may reflect a gaming screen associated with the gaming machine and selections at the user device are mapped to the gaming machine. For example, a live player could make one or more selections (e.g., bets) directly on the gaming machine by touching the screen. A selection at a user device may be mapped and communicated to the gaming machine, so that remote gameplay commands operate the machine similar to a live player operating the gaming machine.

To further promote a live gameplay experience, as discussed herein, a user may switch between various views, displays, and gaming output associated with the gaming machine. As such, as user may view live gaming output, the gaming machine, the gaming floor, and operate the gaming machine just as a player would in person.

Each of the blocks of FIG. 20 may be modified as further discussed herein, such that player input at the user device may switch, as desired, between live video output, live gaming output, and various fields of views from each.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The techniques described above can be implemented on a computing device associated with a gaming device (e.g., a roulette machine operating a live roulette game), a plurality of computing devices associated with a plurality of gaming devices, a controller in communication with the gaming device(s) (e.g., a controller configured to synchronize the gaming devices(s)), or a plurality of controllers in communication with the gaming device(s). Additionally, the techniques may be distributed between the computing device(s) and the controller(s). FIG. 21 illustrates an exemplary block diagram of a computing system that includes hardware modules, software module, and a combination thereof and that can be implemented as the computing device and/or as the server.

In a basic configuration, the computing system may include at least a processor, a system memory, a storage device, input/output peripherals, communication peripherals, and an interface bus. Instructions stored in the memory may be executed by the processor to perform a variety of methods and operations, including the roulette wheel velocity adjustments and result detection optimization, as described above. The computing system components may be present in the gaming device, in a server or other component of a network, or distributed between some combinations of such devices.

The interface bus is configured to communicate, transmit, and transfer data, controls, and commands between the various components of the electronic device. The system memory and the storage device comprise computer readable storage media, such as RAM, ROM, EEPROM, hard-drives, CD-ROMs, optical storage devices, magnetic storage devices, flash memory, and other tangible storage media. Any of such computer readable storage medium can be configured to store instructions or program codes embodying aspects of the disclosure. Additionally, the system memory comprises an operation system and applications. The processor is configured to execute the stored instructions and can comprise, for example, a logical processing unit, a microprocessor, a digital signal processor, and the like.

The system memory and the storage device may also comprise computer readable signal media. A computer readable signal medium may include a propagated data signal with computer readable program code embodied therein. Such a propagated signal may take any of variety of forms including, but not limited to, electro-magnetic, optical, or any combination thereof. A computer readable signal medium may be any computer readable medium that is not a computer readable storage medium and that can communicate, propagate, or transport a program for use in connection with the computing system.

Further, the input and output peripherals include user interfaces such as a keyboard, screen, microphone, speaker, other input/output devices, and computing components such as digital-to-analog and analog-to-digital converters, graphical processing units, serial ports, parallel ports, and universal serial bus. The input/output peripherals may also include a variety of sensors, such as light, proximity, GPS, magnetic field, altitude, and velocity/acceleration. RSSI, and distance sensors, as well as other types of sensors. The input/output peripherals may be connected to the processor through any of the ports coupled to the interface bus.

The user interfaces can be configured to allow a user of the computing system to interact with the computing system. For example, the computing system may include instructions that, when executed, cause the computing system to generate a user interface and carry out other methods and operations that the user can use to provide input to the computing system and to receive an output from the computing system.

This user interface may be in the form of a graphical user interface that is rendered at the screen and that is coupled with audio transmitted on the speaker and microphone and input received at the keyboard. In an embodiment, the user interface can be locally generated at the computing system. In another embodiment, the user interface may be hosted on a remote computing system and rendered at the computing system. For example, the server may generate the user interface and may transmit information related thereto to the computing device that, in turn, renders the user interface to the user. The computing device may, for example, execute a browser or an application that exposes an application program interface (API) at the server to access the user interface hosted on the server.

Finally, the communication peripherals of the computing system are configured to facilitate communication between the computing system and other computing systems (e.g., between the computing device and the server) over a communications network. The communication peripherals include, for example, a network interface controller, modem, various modulators/demodulators and encoders/decoders, wireless and wired interface cards, antenna, and the like.

The communication network includes a network of any type that is suitable for providing communications between the computing device and the server and may comprise a combination of discrete networks which may use different technologies. For example, the communications network includes a cellular network, a Wi-Fi/broadband network, a local area network (LAN), a wide area network (WAN), a telephony network, a fiber-optic network, or combinations thereof. In an example embodiment, the communication network includes the Internet and any networks adapted to communicate with the Internet. The communications network may be also configured as a means for transmitting data between the computing device and the server.

The techniques described above may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile, or non-volatile storage.

In an embodiment, a gaming pod, comprises: a plurality of individual gaming machines, wherein a first individual gaming machine is remotely playable by a user device; and a structure surrounding the plurality of individual gaming machines, wherein the structure defines and at least partially encloses a gaming floor on which the plurality of individual gaming machines is located, and wherein the structure is located on a casino floor.

In an embodiment, wherein the structure comprises a roof above the plurality of individual gaming machines.

In an embodiment, wherein the structure is a dome comprising a rounded roof section sloping downwards and defining an entrance via one or more wall sections.

In an embodiment, wherein the one or more wall sections define at least one vertical opening providing access to the plurality of individual gaming machines.

In an embodiment, wherein the first individual gaming machine is a slot machine.

In an embodiment, wherein a second individual gaming machine is operable by a live player.

In an embodiment, wherein the structure comprises at least one glass section serving as at least one of a window or a player entrance into the gaming pod.

In an embodiment, wherein the structure fully encloses the plurality of individual gaming machines.

In an embodiment, wherein the structure comprises an entrance through which the first individual gaming machine is visible.

In an embodiment, wherein the entrance comprises an arched opening.

In an embodiment, wherein the plurality of individual gaming machines are arranged in a circle on the gaming floor.

In an embodiment, further comprising, on the gaming floor, at least one of: a seating area, a gaming table, a countertop, or a bar.

In an embodiment, wherein the plurality of individual gaming machines are arranged to face outwardly, and wherein the first individual gaming machine is visible through at least one of a wall of the structure or an opening of the structure.

In an embodiment, further comprising a lighting system providing lighting effects to at least one of: an exterior face of the structure, the gaming floor, or an interior area of the structure.

In an embodiment, wherein the lighting system comprises light-emitting diodes (LEDs).

In an embodiment, further comprising a sign mounted to an exterior or the structure.

In an embodiment, further comprising: a gaming system enabling remote play of the first individual gaming machine, wherein the gaming system streams a live video output to the remote user device, and wherein the live video output provides a real-time view of the first individual gaming machine.

In an embodiment, wherein the live video is captured by at least one camera mounted to the structure.

In an embodiment, wherein the gaming system streams live audio output to the user device.

In an embodiment, wherein the user device is a smartphone, a personal computer (PC), or other gaming device.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The terms and descriptions used above are set forth by way of illustration only and are not meant as limitations. Those skilled in the art will recognize that those and many other variations, enhancements and modifications of the concepts described herein are possible without departing from the underlying principles of the invention. The scope of the invention should therefore be determined only by the following claims and their equivalents.

What is claimed is:

1. A gaming pod, comprising:
a plurality of individual gaming machines, wherein a first individual gaming machine is remotely playable by a user device; and
a structure surrounding the plurality of individual gaming machines, wherein the structure defines and at least partially encloses a gaming floor on which the plurality of individual gaming machines is located, and wherein the structure is located on a casino floor.

2. The gaming pod of claim 1, wherein the structure comprises a roof above the plurality of individual gaming machines.

3. The gaming pod of claim 1, wherein the structure is a dome comprising a rounded roof section sloping downwards and defining an entrance via one or more wall sections.

4. The gaming pod of claim 3, wherein the one or more wall sections define at least one vertical opening providing access to the plurality of individual gaming machines.

5. The gaming pod of claim 1, wherein the first individual gaming machine is a slot machine.

6. The gaming pod of claim 1, wherein a second individual gaming machine is operable by a live player.

7. The gaming pod of claim 1, wherein the structure comprises at least one glass section serving as at least one of a window or a player entrance into the gaming pod.

8. The gaming pod of claim 1, wherein the structure fully encloses the plurality of individual gaming machines.

9. The gaming pod of claim 1, wherein the structure comprises an entrance through which the first individual gaming machine is visible.

10. The gaming pod of claim 9, wherein the entrance comprises an arched opening.

11. The gaming pod of claim 1, wherein the plurality of individual gaming machines are arranged in a circle on the gaming floor.

12. The gaming pod of claim 1, further comprising, on the gaming floor, at least one of: a seating area, a gaming table, a countertop, or a bar.

13. The gaming pod of claim 12, wherein the plurality of individual gaming machines are arranged to face outwardly, and wherein the first individual gaming machine is visible through at least one of a wall of the structure or an opening of the structure.

14. The gaming pod of claim 1, further comprising a lighting system providing lighting effects to at least one of: an exterior face of the structure, the gaming floor, or an interior area of the structure.

15. The gaming pod of claim 14, wherein the lighting system comprises light-emitting diodes (LEDs).

16. The gaming pod of claim 1, further comprising a sign mounted to an exterior or the structure.

17. The gaming pod of claim 1, further comprising:
a gaming system enabling remote play of the first individual gaming machine, wherein the gaming system streams a live video output to the remote user device, and wherein the live video output provides a real-time view of the first individual gaming machine.

18. The gaming pod of claim 17, wherein the live video is captured by at least one camera mounted to the structure.

19. The gaming pod of claim 17, wherein the gaming system streams live audio output to the user device.

20. The gaming pod of claim 1, wherein the user device is a smartphone, a personal computer (PC), or other gaming device.
